(19) United States
(12) Patent Application Publication
(10) Pub. No.: US 2020/0108313 A1
(43) Pub. Date: Apr. 9, 2020

(54) EVENT OUTCOME PREDICTING GAME APPARATUS AND METHOD

(71) Applicant: John C House, Toronto (CA)

(72) Inventor: John C House, Toronto (CA)

(21) Appl. No.: 16/153,131

(22) Filed: Oct. 5, 2018

(51) Int. Cl. A63F 13/47; G06F 17/50; A63F 13/35

(52) U.S. Cl. CPC A63F 13/47; A63F 13/35; G06F 17/5009

(57) ABSTRACT

The present invention discloses an Event Outcome predicting game apparatus and method. The apparatus is configured to enable users to selectively predict one or more Outcomes expected to occur during an upcoming Event, such as a sporting Event. The apparatus enables the user to specify Prediction Data, which can include a league selected by the user, one or more Participants and an Outcome for each Participant predicted by the user. The apparatus is further configured to analyze if the predicted Outcome of each selected Participant matches with the Outcome obtained by each selected Participant in a real-time league. The apparatus is further configured to provide rewards and/or an amount of the rewards if the actual Outcomes matches with the predicted Outcomes.

### BACKGROUND OF THE INVENTION

### A. Technical Field

The present invention generally relates to predictive modelling, and more specifically relates to a sport Event Outcome predicting game apparatus and method.

### B. Description of Related Art

Many popular games, for example football, soccer, hockey, basketball, cricket, baseball, are played globally. When played, most of these games, whether at national or international level, are broadcasted, to be shown as live telecasts to spectators. Many people play games related to the telecasted Event. Prior art games have been provided which may be played in conjunction with a sporting Event in progress, where they utilize the Outcomes of real sporting contests.

Canadian Publication No. 2925467A1 to Holt Matthew, discloses a betting system consisting of a betting matrix comprising a plurality of rows and columns wherein each of the row and column in the matrix corresponds to a specific score. User is allowed to select a specific cell in the matrix corresponding to a possible score of a first team.

However, the prior-art systems and methods lacks to disclose a prediction system that involves selection of Participant Prediction Data used to predict an Outcome. Therefore, there is a need for a sport Event Outcome predicting game apparatus and method to enable users to select Prediction Data for each Participant, to selectively predict one or more Outcomes expected to occur during an upcoming Event, such as a sporting Event.

### SUMMARY OF THE INVENTION

The present invention discloses an Event Outcome predicting game apparatus and method. The apparatus is configured to enable a user to selectively predict one or more Outcomes expected to occur during an upcoming Event or league, such as a sporting Event. The apparatus enables the user to specify Prediction Data including one or more Participants and one or more Outcomes for each Participant selected by the user, to predict the actual Outcome of the Event. The apparatus is further configured to provide rewards and/or an amount of the rewards if the actual Outcomes match with the predicted Outcomes.

In one embodiment, the present invention comprises a user device, a network, and an Outcome prediction game system. In an embodiment, the Outcome prediction game system comprises an Outcome prediction game server and at least one database in communication with the server for storing plurality of user related information, plurality of Participant related information, plurality of Prediction Data of each Participant, and plurality of Event related information. The user device associated with the user is enabled to access the apparatus via the network to enable users to selectively predict one or more Outcomes expected to occur during an upcoming sport Event. The server comprises a processor and a memory unit. The memory unit comprises a set of program modules comprises an Event module, a selection module, a prediction model module, a reward module and an auto-play module.

The Event module, executed by the processor, is configured to receive Event data from a 3^{rd} party provider, wherein the Event data includes a league name, league division, teams, Events, and specific Event data like start time, status, scores, individual player points, etc.

The selection module, executed by the processor, is configured to receive Prediction Data from the user, wherein the Prediction Data includes one or more Participants, one or more leagues, and a specific Outcome for each Participant or Participant-league combination predicted by the user.

The prediction model module, executed by the processor, is configured to analyze if the Prediction Data provided by each user for each selected Participant matches with the Outcome from each selected Participant in a real-time league.

The reward module, executed by the processor, is configured to provide reward points to the user if the obtained Outcome matches the predicted Outcome.

The auto play module, executed by the processor, is configured to select the Prediction Data automatically for the user.

In one embodiment, an Event Outcome predicting game method is disclosed. In one embodiment, the method is incorporated in an apparatus comprising a server with a processor and a memory unit, a database in communication with the server for storing plurality of league data, Participant data, Outcome data of each Participant, and a user device configured to access the server via a network. At one step, the method includes, receiving at the processor, via the Event module, Event data from a 3^{rd} party, wherein the Event data includes a league, league division (or other team groupings within league structure). At another step, the method includes, receiving at the processor, via a selection module, Prediction Data from the user, wherein the Prediction Data includes one or more Participants, a league division, and an Outcome of each Participant predicted by the user.

At another step, the method includes, analyzing at the processor, via the prediction model module, if the predicted score or score range of each selected Participant matches with the Outcome obtained by each selected Participant in a real-time league. At another step, the method includes, providing at the processor, via the reward module, reward points to the user if the obtained Outcome is equal to the predicted Outcome. At another step, the method includes, selecting, at the processor, via an auto-play module, the Prediction Data automatically for the user.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 exemplarily illustrates a block diagram of an environment implemented, according to one embodiment of the present invention.

FIG. 2 exemplarily illustrates a block diagram of an Outcome prediction server, according to one embodiment of the present invention.

FIG. 3 is a flowchart illustrating a sport Event Outcome predicting game method, according to one embodiment of the present invention.

FIG. 4 exemplarily illustrates a screenshot of selection of specific combinations of Prediction Data in an embodiment of the present invention.

FIG. 5 exemplarily illustrates a screenshot of selection of Prediction Data comprising Community division and Community score in another embodiment of the present invention.

FIG. 6 exemplarily illustrates a screenshot of reward point provided to the user in an embodiment of the present invention.

FIG. 7 exemplarily illustrates a screenshot of cash value for the reward point provided to the user in an embodiment of the present invention.

FIG. 8 exemplarily illustrates a screenshot of selection of Prediction Data in another embodiment of the present invention.

FIG. 9 exemplarily illustrates a screenshot of reward point provided to the user in another embodiment of the present invention.

FIG. 10 exemplarily illustrates a screenshot of selection of Prediction Data in yet another embodiment of the present invention.

FIG. 11 exemplarily illustrates a screenshot of reward point and respective cash value of the reward point provided to the user in an embodiment of the present invention.

FIG. 12 exemplarily illustrates a screenshot of selection of Prediction Data in yet another embodiment of the present invention.

FIG. 13 exemplarily illustrates a screenshot of reward point provided to the user in yet another embodiment of the present invention.

FIG. 14 exemplarily illustrates a screenshot for selection of specific number of Participants to match specific Outcome in an embodiment of the present invention.

FIG. 15 exemplarily illustrates a screenshot of reward point provided to the user for selection of specific number of Participants to match specific Outcome in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### Definitions

Prediction Data—is defined as a specific score, specific score total or point total, specific score or point combinations, or range of scores or points.

Participant—is defined as a sports team or individual participating in a sporting Event.

Community—is defined as an aspect of a game that is shared amongst all users.

Outcome—is defined as a specific score, score range, point total, point range obtained during a sporting Event by a team or individual participating in the Event.

Event—is defined as a live sporting event or other event where Outcomes are determined during or at the completion of the event.

The present invention discloses an Event Outcome predicting game apparatus and method. The apparatus is configured to enable users to selectively predict one or more Outcomes expected to occur during an upcoming Event, such as a sporting Event. The apparatus enables the user to specify Prediction Data. In an embodiment, the Prediction Data includes one or more Participants and Outcomes for each Participant selected by the user. The apparatus is further configured to provide rewards and/or an amount of the rewards if the actual Outcomes match with the predicted Outcomes. In one embodiment, the Participant is a team or an individual in a sporting Event.

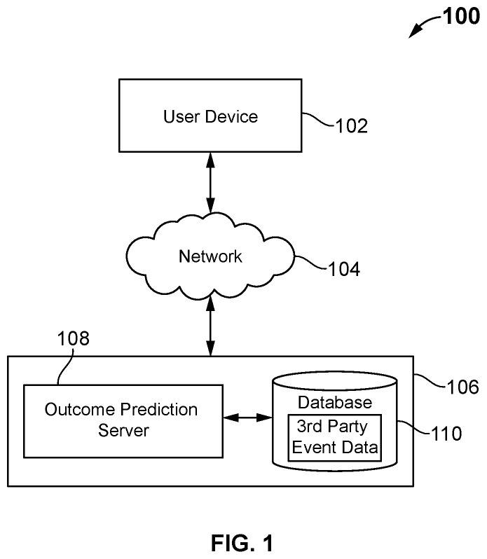

Referring to FIG. 1, a block diagram of an environment 100 implemented in accordance with various embodiments of the present invention is illustrated. The environment 100 comprises a user device 102, a network 104, and an Outcome prediction game apparatus 106, and 3^{rd} party Event data. In an embodiment, the Outcome prediction game apparatus 106 comprises an Outcome prediction game server 108 and at least one database 110. In one embodiment, the 3^{rd} party Event data includes a league name, league division, Participants, Events, and specific Event data like start time, status, scores, individual player points, etc. In one example, the environment 100 could be implemented in a lottery terminal or system, a user or a game player could submit or input their predictions where a paper card would be completed and scanned into the system.

In an embodiment, the user device 102 is configured to access the Outcome prediction game apparatus 106 via the network 104 to enable the users to selectively predict one or more Outcomes expected to occur during an upcoming sport Event. The Outcome prediction game server 108 is configured to evaluate if the actual Outcome matches with the predicted Outcomes or its ranges. Event. In an embodiment, the user device 102 is at least one of a desktop, a laptop, a tablet, a mobile phone, and mobile and/or handheld electronic devices. In an embodiment, the user device 102 is in communication with the network 104 to access the Outcome prediction game server 108. In an embodiment, the network 104 could be Wi-Fi network, WiMax network, and wireless local area network.

In one embodiment, the at least one database 110 may be accessible by the Outcome prediction game server 108. The database 110 may be integrated into the Outcome prediction game server 108 or separate from it. In some embodiments, the database 110 resides in a connected server or in a cloud computing service. Regardless of location, the database 110 comprises a memory to store and organize certain data for use by the server 108. In some embodiments, the database stores a plurality of user related information, a plurality of Participant related information, score ranges related information of each Participant, and plurality of Event related information.

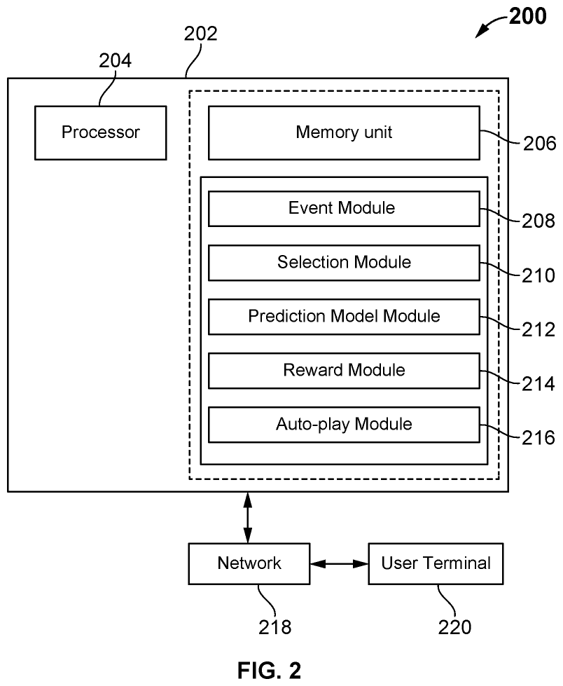

In one embodiment, the Outcome prediction game server 108 is at least one of a general or special purpose computer. The Outcome prediction game server 108 could be operated as a single computer, which can be a hardware and/or software server, a workstation, a desktop, a laptop, a tablet, a mobile phone, a mainframe, a supercomputer, a server farm, and so forth. In some embodiments, the computer could be touchscreen and/or non-touchscreen and adopted to run on any type of OS, such as iOS™, Windows™, Android™, Unix™, Linux™ and/or others. In one embodiment, the plurality of computers is in communication with each other, via networks. Such communication can be via a software application, a mobile app, a browser, an OS, and/or any combination thereof. Further, a block diagram 200 of an exemplary implementation of the Outcome prediction game server (108 or 202) is illustrated in FIG. 2.

FIG. 2 is a block diagram 200 of the Outcome prediction game server 202 in an embodiment of the present invention. The server 202 comprises a processor 204 and a memory unit 206. The memory unit 206 comprises a set of program modules comprises an Event module 208, a selection module 210, a prediction model module 212, a reward module 214 and an auto-play module 216. In one embodiment, the user access server 202 via a user terminal 220 via a network 218. In some embodiments, the network 218 is at least anyone of a Wi-Fi network, WiMax network, and wireless local area network. In some embodiments, the user terminal 220 is at least anyone of a desktop, a laptop, a tablet, a mobile phone, mobile and/or handheld electronic devices, personnel digital assistants, smart phones, smart televisions, palm tops and phablets.

In one embodiment, the server 202 is configured to enable users to selectively predict one or more Outcomes expected to occur during an upcoming Event. In one embodiment, the server 202 is further configured to evaluate if the actual Outcome matches with the predicted Outcome. The Event module 208, executed by the processor 204, is configured to receive Event data from the user, wherein the Event data includes a league or Event selected by the user. The selection module 210, executed by the processor 204, is configured to receive Prediction Data from the user, wherein the Prediction Data includes one or more Participants and an Outcome for each Participant predicted by the user.

The prediction model module 212, executed by the processor 204, is configured to analyze if the predicted score range of each selected Participant matches with a score range obtained by each selected Participant in a real-time league. The reward module 214, executed by the processor 204, is configured to provide reward points to the user if the obtained Outcome is within the predicted Outcome. The auto play module 208, executed by the processor 204, is configured to select the Prediction Data automatically for the user.

The selection module 208, executed by the processor 204, is further configured to enable the user to lock the Outcome predicted for one or more Participants. The selection module 208, executed by the processor 204, is further configured to enable the user to change the Outcome predicted for one or more Participants before or during the real-time league Event. The selection module 208, executed by the processor 204, is further configured to enable the user to change the selected Participant.

In one embodiment, the selection module 208, executed by the processor 204, is further configured to enable the user to use bust insurance, to use wildcards to exchange scores, to select additional Participants, to lock a specific Outcome or sum of total Outcomes, to be able to drop a previously selected Participant and replace with another Participant, to expand an Outcome range, to add an additional Participant, and to view additional Event data.

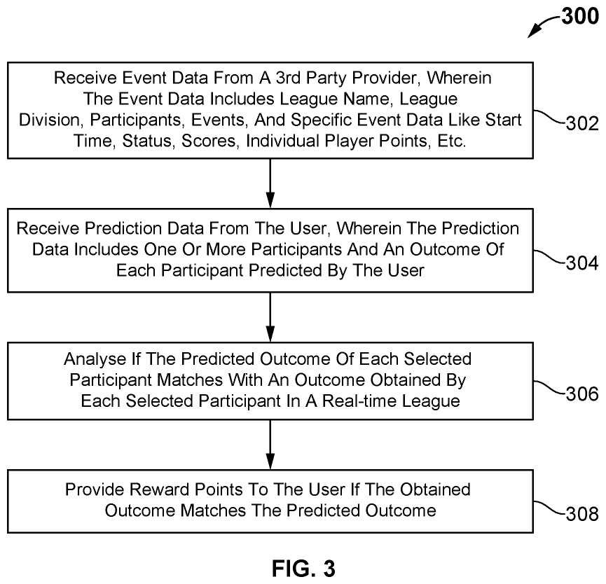

Referring to FIG. 3, a sport Event Outcome predicting game method 300 is illustrated. In one embodiment, the method 300 is incorporated in an apparatus comprising a server with a processor and a memory unit, a database in communication with the server for storing plurality of league data, Participant data, score range data of each Participant, and a user device configured to access the server via a network. At step 302, the method 300 includes, receiving at the processor, via the Event module, an Event data from a user, wherein the Event data includes a league selected by the user. At step 304, the method 300 includes, receiving at the processor, via a selection module, a Prediction Data from the user, wherein the Prediction Data includes one or more Participants and an Outcome for each Participant predicted by the user. At step 306, the method 300 includes, analyzing at the processor, via the prediction model module, if the Outcome of each selected Participant matches with the Outcome obtained by each selected Participant obtained in a real-time league. At step 308, the method 300 includes, providing at the processor, via the reward module, reward points to the user if the prediction of the user is correct. Further, the method 300 includes, selecting, at the processor, via an auto-play module, the Prediction Data automatically for the user.

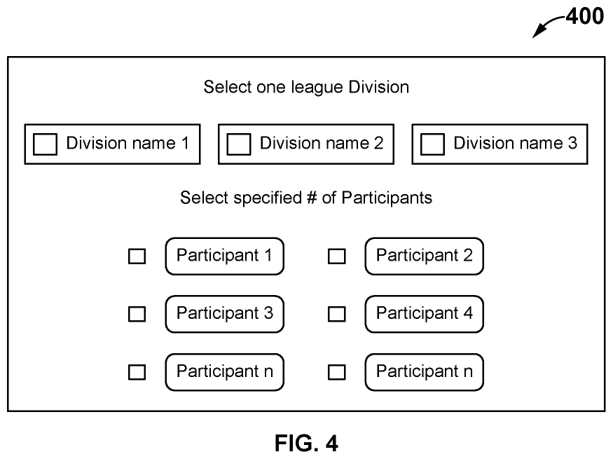

FIG. 4 exemplarily illustrates a screenshot 400 of selection of specific combinations of Prediction Data in an embodiment of the present invention. In one embodiment, the user is enabled to select at least one league division and one or more Participants.

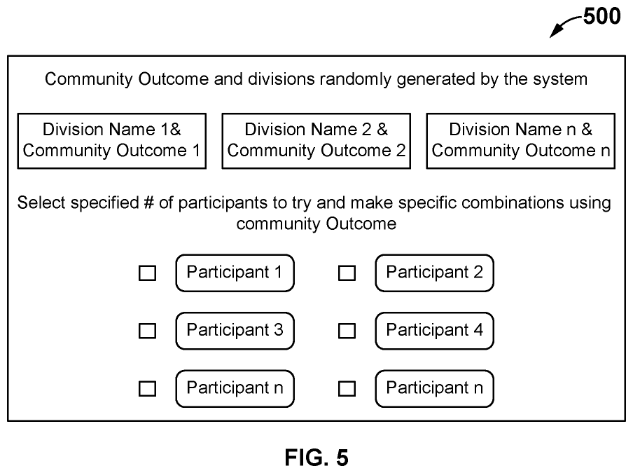

FIG. 5 exemplarily illustrates a screenshot 500 of selection of Prediction Data comprising specific combinations using Community league divisions (or other league groupings) and Outcomes in another embodiment of the present invention. In another embodiment, the apparatus provides randomly generated league division name (or other league grouping) and Community Outcomes.

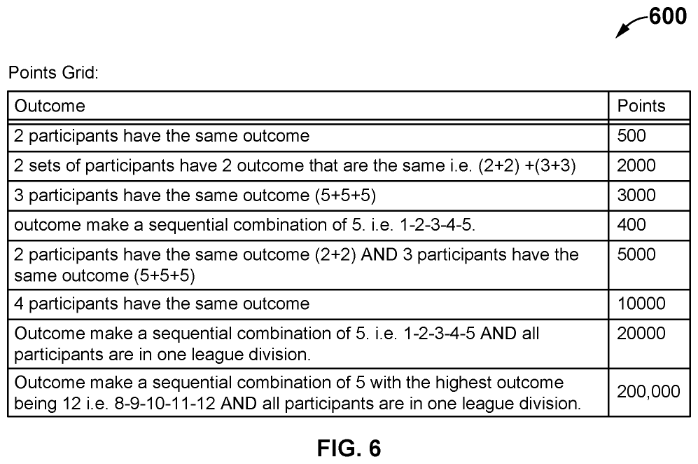

FIG. 6 exemplarily illustrates a screenshot 600 of reward points provided to the user in an embodiment of the present invention. The reward points offered to the user increases exponentially as the number of Outcomes predicted by the user matches with the Outcome of the Event. For example, at least two Participants selected by the user gained the same Outcome as predicted by the user, the points awarded would be a lower number such as 500. In another example, at least three Participants selected by the user gained the same Outcome as predicted by the user, the points awarded would be higher such as 2000.

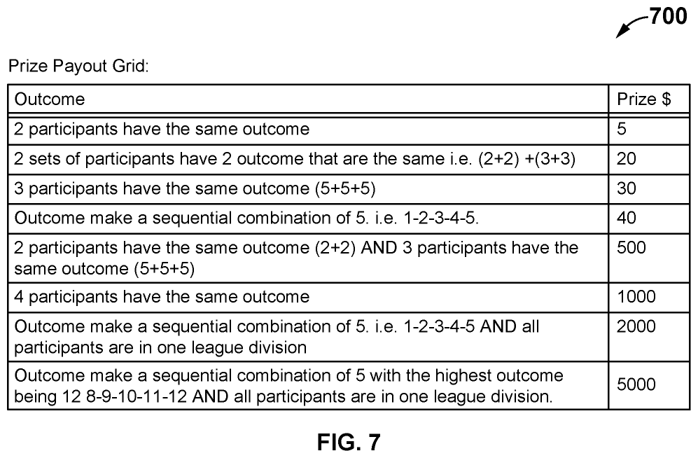

FIG. 7 exemplarily illustrates a screenshot 700 of cash value for the reward points provided to the user in an embodiment of the present invention. For example, at least two Participants selected by the user gained the same Outcome as predicted by the user, the cash value awarded would a lower amount such as 5 dollars. In another example, at least three Participants selected by the user gained the same Outcome as predicted by the user, cash value would be higher, such as 30 dollars.

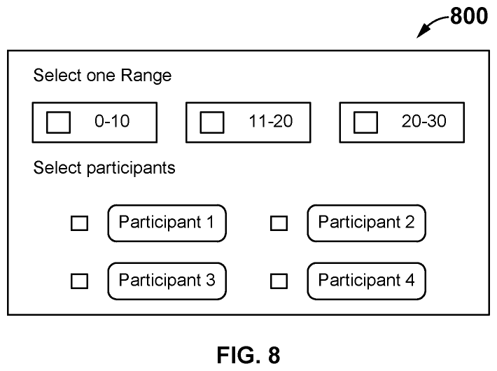

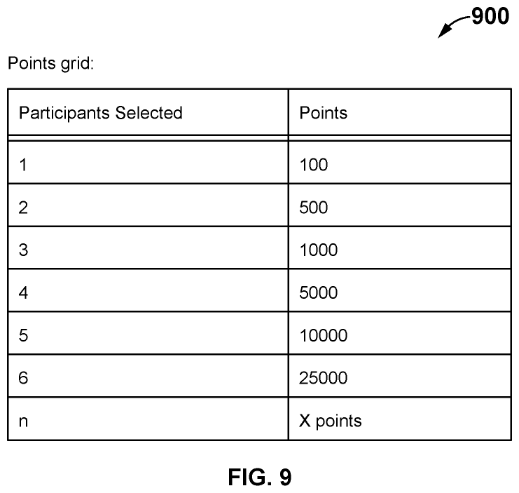

FIG. 8 exemplarily illustrates a screenshot 800 of selection of Prediction Data in another embodiment of the present invention. In this embodiment, the user is enabled to select at least one Outcome, which could be scored by one or more Participants. One or more selected Participants must fall in the chosen range to win points. If the user Prediction Data matches the Outcome of the Event, points would be awarded as per the points grid for that game. An example is shown in the screenshot 900 of FIG. 9.

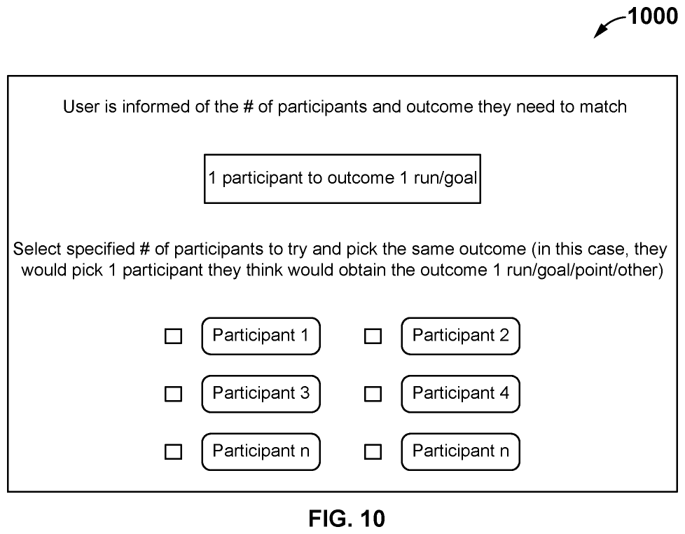

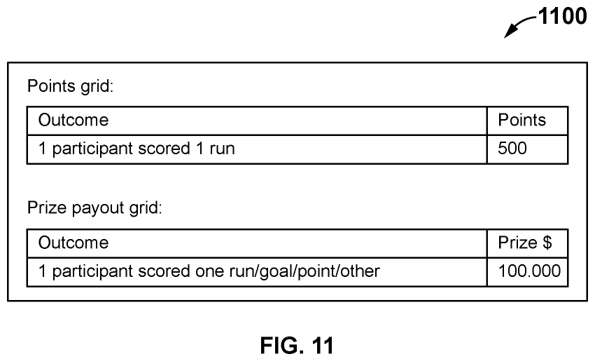

FIG. 10 exemplarily illustrates a screenshot 1000 of selection of Prediction Data in another embodiment of the present invention. In this embodiment, the user is enabled to match a specific Outcome provided by the apparatus. The user will select at least one Participant that they think would obtain the Outcome from the Event. If the selected Participant obtains the specified Outcome, the user is awarded with reward points and/or respective cash value of the reward points provided to the user in an embodiment of the present invention, as illustrated in a screenshot 1100 of FIG. 11.

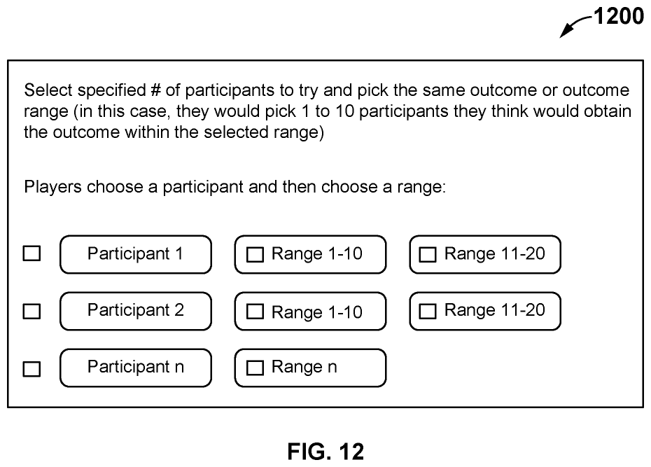

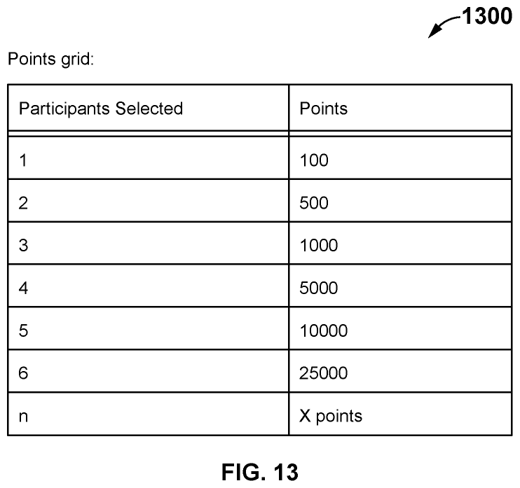

FIG. 12 exemplarily illustrates a screenshot 1200 of selection of Prediction Data in yet another embodiment of the present invention. In this embodiment, the user is enabled to select a specific Participant or Participants and specific Outcome for each Participant. If the user prediction matches the Outcome of the Event, points would be awarded per a points grid. An example screenshot 1300 of reward point provided to the user is shown in FIG. 13.

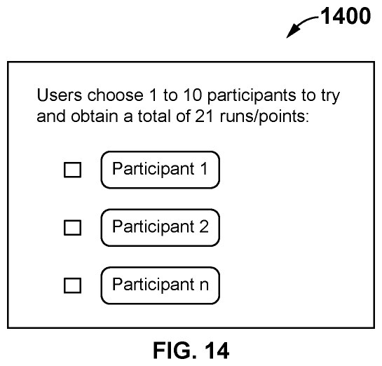

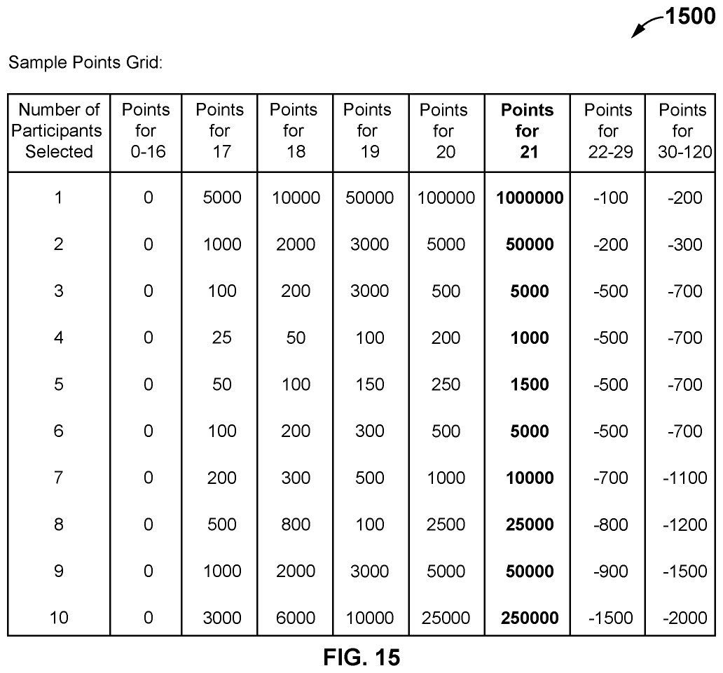

FIG. 14 exemplarily illustrates a screenshot 1400 for selection of specific number of Participants to match specific Outcome in an embodiment of the present invention. In an example, the user is enabled to select one or more Participants that could obtain a specific Outcome, i.e., 21 points. If the Participants selected by the user scores the specific Outcome, reward points are provided to the user. An example screenshot 1500 of the reward points awarded to the user is illustrated in FIG. 15. If the Participants selected by the user scores the specific Outcome such as 21 points or within 21 points, reward points are awarded, as shown in screenshot 1500. If the Participants selected by the user scores above 21 points, negative points are provided, as shown in screenshot 1500.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. An Event Outcome predicting game apparatus, comprising:
a server comprising a processor and a memory unit;
a database in communication with the server for storing plurality of league data, Participant data, Event data, scores, score ranges of data of each Participant and
a user device associated with a user configured to access the server via a network,
wherein the memory unit stores a set of program modules, and
wherein the processor in communication with the memory unit, configured to execute the set of program modules, wherein the set of program modules comprises,
an Event module configured to receive Event data from a 3^{rd} party, wherein the Event data includes league division data;
a selection module configured to receive Prediction Data from the user, wherein the Prediction Data includes one or more league divisions, one or more Participants and an Outcome of each Participant predicted by the user;
a prediction model module configured to analyze if the predicted Outcome of each selected Participant matches with an Outcome obtained by each selected Participant in a real-time league, and
a reward module configured to provide reward points to the user if the obtained Outcome matches the predicted Outcome.

2. The system of claim 1, wherein the Prediction Data includes one or more Participants and a specific Outcome of each Participant predicted by the user.

3. The system of claim 1, wherein the set of program modules further comprises an auto-play module configured to select the Prediction Data automatically for the user.

4. The system of claim 1, wherein the selection module is further configured to enable the user to lock the score range predicted for one or more Participants.

5. The system of claim 1, wherein the selection module is further configured to enable the user to change the Outcome predicted for one or more Participants before or during the real-time league Event.

6. The system of claim 1, wherein the selection module is further configured to enable the user to change the selected Participant.

7. The system of claim 1, wherein the Participant is an individual player.

8. The system of claim 1, wherein the Participant is a team.

9. The system of claim 1, wherein the user device is at least one of tablet computer, personnel computer, personnel digital assistant, smart phone, smart television, palm top, phablet, laptop, or a device with computational capability connected to the internet.

10. The system of claim 1, wherein the memory unit is at least one of a volatile memory, non-volatile memory, read only memory (ROM), random access memory (RAM), and a flash memory.

11. The system of claim 1, wherein the network is at least one of a Local Area Network, a Wide Area Network, a Wireless Network, a telecommunication network, a mobile network, and an Internet.

12. An Event Outcome predicting game method, incorporated in an apparatus comprising a server with a processor and a memory unit, a database in communication with the server for storing plurality of league data, Participant data, scores, Outcome data of each Participant, and a user device configured to access the server via a network, comprising the steps of:
receiving at the processor, via an Event module, Event data from a 3rd party.
receiving at the processor, via a selection module, a Prediction Data from the user, wherein the Prediction Data includes one or more Participants and an Outcome for each Participant predicted by the user;
analyzing at the processor, via a prediction model module, if Outcome of each selected Participant matches with the Outcome obtained by each selected Participant obtained in a real-time league, and
providing at the processor, via a reward module, reward points to the user if the prediction of the user is correct.

13. The method of claim 12, wherein the Prediction Data includes one or more Participants and a specific Outcome of each Participant predicted by the user.

14. The method of claim 12, further comprising a step of: selecting, at the processor, via an auto-play module, the Prediction Data automatically for the user.

15. The method of claim 12, further comprising a step of: enabling at the processor, via the selection module, enable the user to lock the Outcome predicted for one or more Participants.

16. The method of claim 12, further comprising a step of: enabling at the processor, via the selection module, enable the user to change the Outcome predicted for one or more Participants before or during the real-time league Event.

17. The method of claim 12, further comprising a step of: enabling at the processor, via the selection module, the user to change the selected Participant.

18. The method of claim 12, wherein the Participant is an individual player.

19. The method of claim 12, wherein the Participant is a team.

20. The method of claim 12, wherein the user device is at least one of tablet computer, personnel computer, personnel digital assistant, smart phone, smart television, palm top, phablet, laptop, or a device with computational capability connected to the internet.
